(19) United States
(12) Patent Application Publication
(10) Pub. No.: US 2025/0250687 A1
(43) Pub. Date: Aug. 7, 2025

(54) WATER ELECTROLYSIS SYSTEM

(71) Applicant: HONDA MOTOR CO., LTD., TOKYO (JP)

(72) Inventor: Shuichiro KOJIMA, WAKO-SHI (JP)

(21) Appl. No.: 19/023,852

(22) Filed: Jan. 16, 2025

(30) Foreign Application Priority Data
Feb. 7, 2024 (JP) 2024-017094

(51) Int. Cl. C25B 1/04; C25B 9/70; C25B 15/033

(52) U.S. Cl. CPC C25B 1/04; C25B 9/70; C25B 15/033

(57) ABSTRACT

A water electrolysis system includes a flow rate adjusting valve for relatively changing a first flow rate which is a flow rate of water flowing through a first flow path portion extending from a first water lead-out unit, and a second flow rate which is a flow rate of water flowing through a second flow path portion extending from a second water lead-out unit.

### CROSS-REFERENCE TO RELATED APPLICATIONS

This application is based upon and claims the benefit of priority from Japanese Patent Application No. 2024-017094 filed on Feb. 7, 2024, the contents of which are incorporated herein by reference.

### BACKGROUND OF THE INVENTION

### Field of the Invention

The present invention relates to a water electrolysis system.

### Description of the Related Art

JP 2019-123899 A discloses a water electrolysis system including a water electrolysis stack. In this water electrolysis stack, a plurality of water electrolysis cells are stacked. The water electrolysis stack is installed such that the stacking direction of the water electrolysis cells lies along the vertical direction.

### SUMMARY OF THE INVENTION

In recent years, it has been desired to efficiently electrolyze water.

The present invention has the object of solving the aforementioned problem.

According to an aspect of the present disclosure, there is provided a water electrolysis system provided with a water electrolysis stack including a plurality of water electrolysis cells stacked in a direction lying along a vertical direction, a water introduction unit, a first water lead-out unit, and a second water lead-out unit, wherein the first water lead-out unit is provided on an upper side of the water electrolysis stack, the second water lead-out unit is provided on a lower side of the water electrolysis stack, and the water introduction unit is provided between the first water lead-out unit and the second water lead-out unit in a stacking direction of the water electrolysis cells, the water electrolysis system comprising a flow rate adjusting valve configured to relatively change a first flow rate that is a flow rate of water flowing through a first flow path portion extending from the first water lead-out unit, and a second flow rate that is a flow rate of the water flowing through a second flow path portion extending from the second water lead-out unit.

According to the aspect of the present disclosure, electrolysis can be efficiently performed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing a water electrolysis system according to an embodiment;

FIG. 2 is a flowchart showing a procedure of an opening degree changing operation of a flow rate adjusting valve;

FIG. 3A is a graph showing the behavior of the voltage or resistance of a water electrolysis cell; and

FIG. 3B is a graph showing the behavior of the flow rate of water that is discharged from the water electrolysis stack.

### DETAILED DESCRIPTION OF THE INVENTION

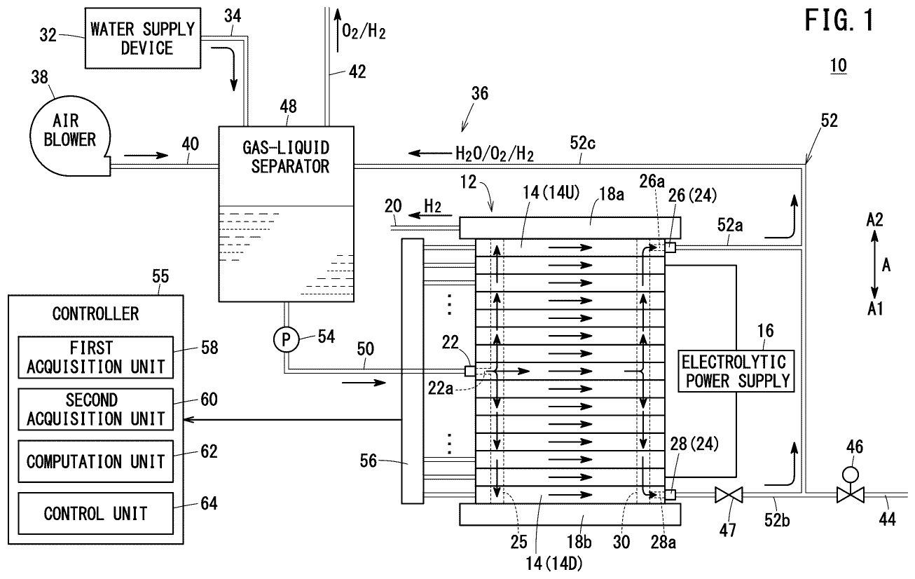

FIG. 1 is a diagram showing a water electrolysis system 10 according to an embodiment. In FIG. 1, an arrow A1 direction indicates a gravity direction, and an arrow A2 direction indicates a direction opposite to the gravity direction. The water electrolysis system 10 includes a water electrolysis stack 12 that produces oxygen (at normal pressure) and hydrogen (at higher pressure than oxygen) by electrolyzing water.

The water electrolysis stack 12 includes a plurality of water electrolysis cells 14 stacked on each other. The water electrolysis cells 14 are each formed, for example, in a disk shape. Although detailed illustration thereof is omitted, each of the water electrolysis cells 14 includes a membrane electrode assembly, and an anode separator and a cathode separator disposed on both sides of the membrane electrode assembly. The membrane electrode assembly includes an electrolyte membrane, and an anode current collector (anode) and a cathode current collector (cathode) provided on both sides of the electrolyte membrane in a thickness direction thereof. In the present embodiment, the water electrolysis cell 14 is a PEM cell in which a proton exchange membrane is used as the electrolyte membrane.

The water electrolysis stack 12 is installed such that the stacking direction of the water electrolysis cells 14 lies along the vertical direction (an arrow A direction). An electrolytic power supply 16, which is a DC power supply, is connected to the water electrolysis stack 12. The electrolytic power supply 16 is connected to the water electrolysis cells 14 on both sides among the water electrolysis cells 14 connected in series, for example. End plates 18a and 18b are disposed at both ends in the stacking direction of the plurality of water electrolysis cells 14. A hydrogen lead-out path 20 which communicates with cathode sides (high-pressure hydrogen generating sides) of the respective water electrolysis cells 14 is connected to the end plate 18a located on the upper side.

A water introduction unit 22 and a water lead-out unit 24 are provided in the water electrolysis stack 12. A water inlet port 22a through which water is introduced into the water electrolysis stack 12 is formed in the water introduction unit 22. The water inlet port 22a communicates with a water introducing communication passage 25 which is provided so as to penetrate through the water electrolysis cells 14 in the stacking direction. The water introducing communication passage 25 allows water introduced from the water inlet port 22a of the water introduction unit 22 to flow in the stacking direction. The water introducing communication passage 25 communicates with anode inlet sides (water supply inlet sides) of the water electrolysis cells 14.

The water introduction unit 22 is provided in the water electrolysis cell 14 positioned between both ends (in the middle) in the stacking direction among the plurality of water electrolysis cells 14. Specifically, the water introduction unit 22 is provided in the water electrolysis cell 14 positioned in a central region in the stacking direction among the plurality of water electrolysis cells 14. The central region, for example, is a middle region obtained by dividing the plurality of water electrolysis cells 14 into three equal parts in the stacking direction. However, the central region, for example, may be a middle region obtained by dividing the plurality of water electrolysis cells 14 into three parts at a ratio of 1:2:1 in the stacking direction.

The water lead-out unit 24 includes a first water lead-out unit 26 and a second water lead-out unit 28. The first water lead-out unit 26 is provided in the water electrolysis cell 14 (on an upper end side of the water electrolysis stack 12) located at the upper end (one end) in the stacking direction among the plurality of water electrolysis cells 14. Specifically, the first water lead-out unit 26 is positioned upper (further in the arrow A2 direction) than the water introduction unit 22. A first water outlet port 26a through which unreacted water (surplus water) which has not been electrolyzed is led out from the interior of the water electrolysis stack 12 is formed in the first water lead-out unit 26.

The second water lead-out unit 28 is provided in the water electrolysis cell 14 (on a lower end side of the water electrolysis stack 12) located at the lower end (the other end) in the stacking direction among the plurality of water electrolysis cells 14. Specifically, the second water lead-out unit 28 is positioned lower (further in the arrow A1 direction) than the water introduction unit 22 and the first water lead-out unit 26. A second water outlet port 28a through which unreacted water (surplus water) which has not been electrolyzed is led out from the interior of the water electrolysis stack 12 is formed in the second water lead-out unit 28.

The first water lead-out unit 26 and the second water lead-out unit 28 are disposed at positions, respectively, which are shifted in phase from the water introduction unit 22 by 180° in a circumferential direction of the water electrolysis stack 12. The first water outlet port 26a and the second water outlet port 28a communicate respectively with a water lead-out communication passage 30 which is provided so as to penetrate through the water electrolysis cells 14 in the stacking direction. The water lead-out communication passage 30 communicates with anode outlet sides (water and oxygen discharge sides) of the water electrolysis cells 14, allows the unreacted water which has not been electrolyzed to flow in the stacking direction, and guides the unreacted water to the first water lead-out unit 26 and the second water lead-out unit 28.

The water electrolysis system 10 includes a water supply device 32, a water supply path 34, a water circulation circuit 36, an air blower 38, an air supply path 40, an air discharge path 42, a drain flow path 44, an on-off valve 46, and a flow rate adjusting valve 47.

The water supply device 32 guides water to the water circulation circuit 36. The water may be pure water. The water circulation circuit 36 includes a gas-liquid separator 48, a water supply path 50, a water discharge path 52, and a circulation pump 54. The water supply path 34 is connected to an upper portion of the gas-liquid separator 48. The gas-liquid separator 48 functions as a tank in which water is stored. It should be noted that, in the case of an AEM cell in which an anion exchange membrane is used as the electrolyte membrane, alkaline water may be supplied to the water electrolysis cells 14.

The water supply path 50 connects a bottom portion of the gas-liquid separator 48 and the water introduction unit 22 to each other. The water supply path 50 guides the water stored in the gas-liquid separator 48, to the water introduction unit 22. The water discharge path 52 connects the first water lead-out unit 26 and the second water lead-out unit 28 respectively to the upper portion of the gas-liquid separator 48. The water discharge path 52 guides a mixed fluid into the gas-liquid separator 48. The mixed fluid contains unreacted water that has not been electrolyzed, oxygen generated by the reaction, and hydrogen that has permeated from the cathode side to the anode side.

The water discharge path 52 includes a first flow path portion 52a extending from the first water lead-out unit 26, a second flow path portion 52b extending from the second water lead-out unit 28, and a third flow path portion 52c to which the first flow path portion 52a and the second flow path portion 52b are connected. The second flow path portion 52b is positioned lower than the first flow path portion 52a and the third flow path portion 52c. In other words, the second flow path portion 52b is positioned at a lowermost location of the water discharge path 52.

The circulation pump 54 is provided, for example, in the water supply path 50. The circulation pump 54 circulates water so that water stored in the gas-liquid separator 48 is supplied from the water introduction unit 22 into the water electrolysis stack 12 through the water supply path 50, and unreacted water that has not been electrolyzed inside the water electrolysis stack 12 is discharged from the water lead-out unit 24 to the gas-liquid separator 48 through the water discharge path 52.

In the water circulation circuit 36 which is configured in this manner, the second water lead-out unit 28 is positioned lower than the gas-liquid separator 48, the water supply path 50, and the circulation pump 54, and is connected to the lowermost part (the second flow path portion 52b) of the water discharge path 52.

The air blower 38 is an air supply device for guiding diluting air into the gas-liquid separator 48 via the air supply path 40. The air supply path 40 and the air discharge path 42 are connected to the upper portion of the gas-liquid separator 48. Oxygen and hydrogen inside the gas-liquid separator 48 are discharged into the air discharge path 42 together with the air guided from the air blower 38.

The drain flow path 44 is a flow path for discharging water in the water circulation circuit 36 and the water electrolysis stack 12 to the outside. The drain flow path 44 is connected to the lowermost part (the second flow path portion 52b) of the water discharge path 52. The on-off valve 46 is provided in the drain flow path 44. The on-off valve 46 is configured in the form of a solenoid valve that opens and closes the drain flow path 44.

The flow rate adjusting valve 47 is provided in the second flow path portion 52b. The flow rate adjusting valve 47 adjusts the flow rate of the water that flows through the second flow path portion 52b by changing the opening degree relative to the second flow path portion 52b. When the flow rate of the water flowing through the second flow path portion 52b decreases, the flow rate of the water flowing through the first flow path portion 52a inevitably increases. In contrast thereto, when the flow rate of the water flowing through the second flow path portion 52b increases, the flow rate of the water flowing through the first flow path portion 52a inevitably decreases. That is, the flow rate adjusting valve 47 relatively changes a first flow rate which is a flow rate of the water flowing through the first flow path portion 52a and a second flow rate which is a flow rate of the water flowing through the second flow path portion 52b.

The water electrolysis system 10 is equipped with a controller 55 that carries out control of operations of the water electrolysis system 10 as a whole. The controller 55 is a computer including a microcomputer. The controller 55 includes a central processing unit (CPU), and a ROM, a RAM, and the like serving as memories. A detection unit 56 is connected to the controller 55. The detection unit 56 detects information indicating the resistance (or voltage) of each of the plurality of water electrolysis cells 14. The detection unit 56 includes a voltage sensor that detects the voltage of the water electrolysis cells 14. The detection unit 56 may include a resistance sensor that detects the resistance of the water electrolysis cells 14. The detection unit 56 may include a current sensor that detects a current flowing through the electrolytic power supply 16.

The CPU reads and executes a program stored in the ROM, and thereby the controller 55 operates as a first acquisition unit 58, a second acquisition unit 60, a computation unit 62, and a control unit 64. At least one of the first acquisition unit 58, the second acquisition unit 60, the computation unit 62, or the control unit 64 may be constituted by a function realizing device as hardware.

The first acquisition unit 58 uses the detection unit 56 to acquire information indicating the resistance of an upper cell 14U. When a gas in the mixed fluid stays on the upper cell 14U side, the flow cross-sectional area of the current flowing through the anode current collector (the anode) and the cathode current collector (the cathode) decreases, and the resistance value increases. The upper cell 14U is one of the plurality of water electrolysis cells 14 that is located on the upper side in the stacking direction. The upper cell 14U may be the water electrolysis cell 14 located at the uppermost position in the stacking direction. The second acquisition unit 60 uses the detection unit 56 to acquire information indicating the resistance of a lower cell 14D. The lower cell 14D is one of the plurality of water electrolysis cells 14 that is located on the lower side in the stacking direction. The lower cell 14D may be the water electrolysis cell 14 located at the lowermost position in the stacking direction.

The computation unit 62 performs calculation based on the information indicating the resistance as acquired by the first acquisition unit 58, and the information indicating the resistance as acquired by the second acquisition unit 60. The control unit 64 controls driving and stopping of the circulation pump 54, controls driving and stopping of the air blower 38, and controls opening and closing operations of the on-off valve 46. Further, the control unit 64 controls an opening degree changing operation of the flow rate adjusting valve 47. The opening degree changing operation of the flow rate adjusting valve 47 is an operation of changing the opening degree of the flow rate adjusting valve 47 relative to the second flow path portion 52b.

The water electrolysis system 10 which is configured as described above operates in the following manner.

When the circulation pump 54 is driven, the water in the gas-liquid separator 48 is supplied to the water introduction unit 22 (in the water electrolysis cell 14 positioned at substantially the center in the stacking direction) via the water supply path 50. The water supplied to the water introduction unit 22 flows into the water introducing communication passage 25, flows upward and downward (in the stacking direction), and is distributed to the anode inlet side of each of the water electrolysis cells 14.

At this time, when a voltage is applied to the water electrolysis stack 12 by the electrolytic power supply 16, water is electrolyzed on the anode side of each of the water electrolysis cells 14. When the water is electrolyzed, hydrogen ions, electrons, and oxygen are generated on the anode side of each of the water electrolysis cells 14. On the other hand, on the cathode side of each of the water electrolysis cells 14, hydrogen ions are combined with electrons to obtain hydrogen. This hydrogen is taken out to the hydrogen lead-out path 20 to thereby become dry hydrogen (product hydrogen), which is supplied to a fuel cell electric vehicle (not shown) or the like.

On the other hand, on the anode outlet side, oxygen generated by the reaction, unreacted water which has not been electrolyzed, and hydrogen which has permeated flow. A mixed fluid containing the oxygen, water, and hydrogen is led out into the water lead-out communication passage 30 and flows upward and downward (in the stacking direction). The mixed fluid that has flowed upward through the water lead-out communication passage 30 is guided into the first flow path portion 52a via the first water lead-out unit 26. The mixed fluid that has flowed downward through the water lead-out communication passage 30 is guided into the second flow path portion 52b via the second water lead-out unit 28.

The mixed fluid in the first flow path portion 52a and the mixed fluid in the second flow path portion 52b are joined together in the third flow path portion 52c, are guided into the upper portion of the gas-liquid separator 48, and are separated into a liquid (water) and gases (oxygen and hydrogen). In this case, the on-off valve 46 closes the drain flow path 44.

The water separated from the mixed fluid is stored in the gas-liquid separator 48. The water stored in the gas-liquid separator 48 is caused to flow out to the water supply path 50 by the circulation pump 54. The oxygen and hydrogen that are separated from the mixed fluid are discharged to the outside from the air discharge path 42 by the air blower 38.

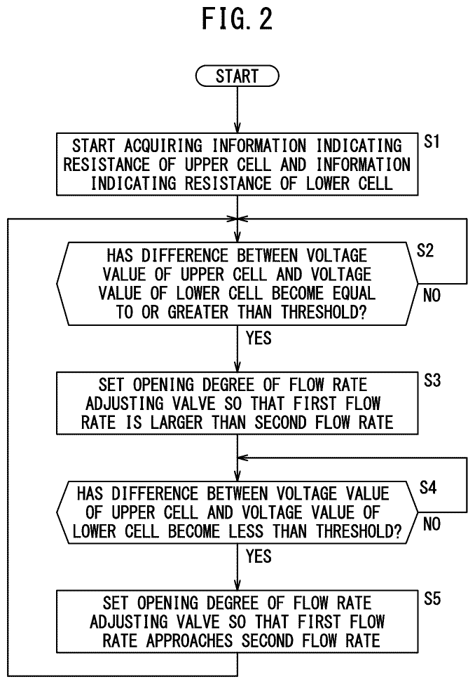

Next, the opening degree changing operation of the flow rate adjusting valve 47 will be described. The opening degree changing operation of the flow rate adjusting valve 47 is performed during the operation period of the water electrolysis system 10. FIG. 2 is a flowchart showing a procedure of the opening degree changing operation of the flow rate adjusting valve 47.

In step S1, the first acquisition unit 58 starts acquiring first information. The second acquisition unit 60 starts acquiring second information. The first information is information indicating the resistance of the upper cell 14U as detected by the detection unit 56 in a state where a predetermined current is flowing through the upper cell 14U. The second information is information indicating the resistance of the lower cell 14D as detected by the detection unit 56 in a state where a predetermined current is flowing through the lower cell 14D. The first information and the second information are stored in the memory together with the time at which they are acquired. A current sensor (not shown) or the like that detects a current flowing through the electrolytic power supply 16 may be used to acquire the first information and the second information. When the acquisition of the first information and the second information is started, the process proceeds to a voltage value comparison process of step S2.

In step S2, the computation unit 62 calculates a difference (degree of separation) in voltage value between the upper cell 14U and the lower cell 14D, based on the first information and the second information stored in the memory immediately before. The difference in the voltage value may be an absolute value of the difference in the voltage value. The computation unit 62 may calculate the difference in resistance value between the upper cell 14U and the lower cell 14D. The difference in the resistance value may be an absolute value of the difference in the resistance value.

The control unit 64 compares the difference in the voltage value between the upper cell 14U and the lower cell 14D calculated by the computation unit 62 with a threshold. In a case where the difference in the voltage value between the upper cell 14U and the lower cell 14D is less than the threshold (step S2: NO), the opening degree changing operation does not proceed to step S3. In this case, the calculation by the computation unit 62 and the comparison by the control unit 64 are repeated. On the other hand, when the difference in the voltage value between the upper cell 14U and the lower cell 14D becomes equal to or greater than the threshold (step S2: YES), it is determined that the gas in the mixed fluid stays on the upper cell 14U side, and the process proceeds to the opening degree changing operation of step S3.

In step S3, the control unit 64 sets the opening degree of the flow rate adjusting valve 47 so that the first flow rate (the flow rate of the water flowing through the first flow path portion 52a) is larger than the second flow rate (the flow rate of the water flowing through the second flow path portion 52b). Specifically, the control unit 64 sets the opening degree of the flow rate adjusting valve 47 to be smaller than a predetermined opening degree. When the opening degree of the flow rate adjusting valve 47 is set, the process proceeds to a voltage value comparison step of step S4.

In step S4, the computation unit 62 calculates a difference (degree of separation) in voltage value between the upper cell 14U and the lower cell 14D, based on the first information and the second information stored in the memory immediately before. The control unit 64 compares the difference in the voltage value between the upper cell 14U and the lower cell 14D calculated by the computation unit 62 with the threshold. In a case where the difference in the voltage value between the upper cell 14U and the lower cell 14D is still equal to or greater than the threshold (NO in step S4), the opening degree changing operation does not proceed to step S5. In this case, the calculation by the computation unit 62 and the comparison by the control unit 64 are repeated. On the other hand, when the difference in the voltage value between the upper cell 14U and the lower cell 14D becomes less than the threshold (step S4: YES), it is determined that the gas that has stayed on the upper cell 14U side has been discharged, and the process proceeds to the opening degree changing operation of step S5.

In step S5, the control unit 64 sets the opening degree of the flow rate adjusting valve 47 so that the first flow rate (the flow rate of the water flowing through the first flow path portion 52a) approaches the second flow rate (the flow rate of the water flowing through the second flow path portion 52b). Specifically, the control unit 64 sets the opening degree of the flow rate adjusting valve 47 to the predetermined opening degree. When the opening degree of the flow rate adjusting valve 47 is set, the opening degree changing operation proceeds to step S2.

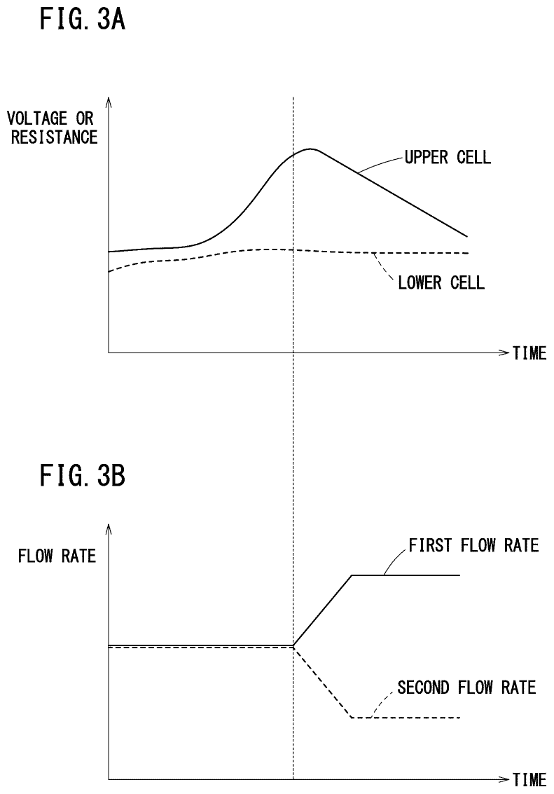

FIG. 3A is a graph showing the behavior of the voltage or resistance of the water electrolysis cell 14, and FIG. 3B is a graph showing the behavior of the flow rate of the water discharged from the water electrolysis stack 12.

Oxygen generated on the anode sides of the water electrolysis cells 14 by the electrolysis of water is present as air bubbles in the water supplied to the anode sides of the water electrolysis cells 14. Further, the air bubbles rise due to buoyancy. Therefore, the higher the water electrolysis cell 14 is disposed in the stacking direction, the more easily the air bubbles rising through the water lead-out communication passage 30 accumulate in the vicinity of the anode current collector. As shown in FIG. 3A, the air bubbles accumulate in the anode current collector with the passage of time, and the resistance or voltage of the water electrolysis cell 14 increases. This is because when the air bubbles accumulate in the anode current collector, the contact area between the anode current collector and water is reduced. That is, the air bubbles can be a resistor. Therefore, as the number of air bubbles accumulating in the anode current collector increases, the electrolysis efficiency of the water electrolysis cell 14 decreases.

In the present embodiment, the computation unit 62 calculates the difference between the voltage value of the upper cell 14U in the state where the predetermined current is flowing therethrough, and the voltage value of the lower cell 14D in the state where the predetermined current is flowing therethrough. Therefore, the degree to which the air bubbles accumulate in the anode current collector can be estimated in a favorable manner.

Further, in the present embodiment, in a case where the above-described difference is equal to or greater than the threshold, the control unit 64 sets the opening degree of the flow rate adjusting valve 47 to be smaller than the predetermined opening degree. Therefore, as shown in FIG. 3B, the first flow rate (the flow rate of the water flowing through the first flow path portion 52a) increases with the passage of time. On the other hand, the second flow rate (the flow rate of the water flowing through the second flow path portion 52b) decreases with the passage of time. That is, the first flow rate is changed to be larger than the second flow rate. This makes it possible to favorably discharge the air bubbles accumulated in the anode current collectors from the water electrolysis stack 12. As a result, water can be efficiently electrolyzed.

The above embodiment may be modified as follows.

For example, the control unit 64 may set the opening degree of the flow rate adjusting valve 47 so that the first flow rate becomes larger than the second flow rate as the above-described difference increases. This can reduce the accumulation of the air bubbles in the anode current collectors.

Alternatively, the computation unit 62 may calculate a difference between a first flow rate detected by a first flow rate sensor provided in the first flow path portion 52a, and a second flow rate detected by a second flow rate sensor provided in the second flow path portion 52b.

Alternatively, the flow rate adjusting valve 47 may be provided in the first flow path portion 52a instead of the second flow path portion 52b. In this case, for example, the flow rate adjusting valve 47 is provided in the first flow path portion 52a having a larger cross-sectional area than the cross-sectional area of the second flow path portion 52b. Further, the predetermined opening degree of the flow rate adjusting valve 47 is set so that the cross-sectional area of the first flow path portion 52a is equal to the cross-sectional area of the second flow path portion 52b. Further, in step S3, the control unit 64 sets the opening degree of the flow rate adjusting valve 47 to be larger than the predetermined opening degree. Consequently, the same effect as that of the above-described embodiment can be obtained.

Alternatively, the water electrolysis cell 14 may be an AEM cell. In this case, the water supply device 32 guides alkaline water to the water circulation circuit 36.

Alternatively, in the water electrolysis stack 12, the anode current collector (the anode) and the cathode current collector (the cathode) may be reversed. In this case, the water introducing communication passage 25 communicates with cathode inlet sides of the water electrolysis cells 14. In each of the water electrolysis cells 14, water is electrolyzed on the cathode side. When water is electrolyzed, hydrogen is generated on the cathode side of each of the water electrolysis cells 14. On the other hand, oxygen is obtained on the anode side of each of the water electrolysis cells 14. This oxygen is taken out to the hydrogen lead-out path 20.

As described above, in the present embodiment, the flow rate adjusting valve 47 is provided which relatively changes the flow rate of the water flowing through the first flow path portion 52a located on the upper side of the water electrolysis stack 12, and the flow rate of the water flowing through the second flow path portion 52b located on the lower side of the water electrolysis stack 12. This makes it possible to make the flow rate of the water on the upper side of the water electrolysis stack 12 larger than the flow rate of the water on the lower side of the water electrolysis stack 12. Therefore, even if the gas that exists as air bubbles in the water as a result of the electrolysis of the water rises due to buoyancy, the air bubbles can be discharged to the first flow path portion 52a without being accumulated in the water electrolysis cell 14 positioned on the upper side. Therefore, it is possible to reduce the possibility that the electrolysis of water is hindered by the air bubbles, and as a result, it is possible to efficiently electrolyze water.

The following supplementary notes are further disclosed in relation to the above-described embodiment.

### Supplementary Note 1

The water electrolysis system (10) of the present disclosure is provided with the water electrolysis stack (12) including the plurality of water electrolysis cells (14) stacked in a direction lying along the vertical direction, the water introduction unit (22), the first water lead-out unit (26), and the second water lead-out unit (28), wherein the first water lead-out unit is provided on the upper side of the water electrolysis stack, the second water lead-out unit is provided on the lower side of the water electrolysis stack, and the water introduction unit is provided between the first water lead-out unit and the second water lead-out unit in the stacking direction of the water electrolysis cells, the water electrolysis system including the flow rate adjusting valve (47) configured to relatively change the first flow rate that is the flow rate of the water flowing through the first flow path portion (52a) extending from the first water lead-out unit, and the second flow rate that is the flow rate of the water flowing through the second flow path portion (52b) extending from the second water lead-out unit.

### Supplementary Note 2

The water electrolysis system according to Supplementary Note 1 may further include the detection unit (56) configured to detect information indicating the resistance of each of the—plurality of water electrolysis cells, the first acquisition unit (58) configured to acquire, in a state where a predetermined current flows through the upper cell (14U) which is one of the water electrolysis cells that is located on the upper side in the stacking direction, the information of the upper cell detected by the detection unit, the second acquisition unit (60) configured to acquire, in a state where a predetermined current flows through the lower cell (14D) which is one of the water electrolysis cells that is located on the lower side in the stacking direction, the information of the lower cell detected by the detection unit, the computation unit (62) configured to calculate a difference in voltage value or resistance value between the upper cell and the lower cell based on the information acquired by the first acquisition unit and the information acquired by the second acquisition unit, and the control unit (64) configured to set the opening degree of the flow rate adjusting valve based on the difference.

### Supplementary Note 3

In the water electrolysis system according to Supplementary Note 2, in a case where the difference is equal to or greater than a threshold, the control unit may set the opening degree of the flow rate adjusting valve in a manner so that the first flow rate is larger than the second flow rate.

### Supplementary Note 4

In the water electrolysis system according to Supplementary Note 3, when the difference that has become equal to or greater than the threshold becomes less than the threshold, the control unit may set the opening degree of the flow rate adjusting valve in a manner so that the first flow rate approaches the second flow rate.

### Supplementary Note 5

In the water electrolysis system according to Supplementary Note 2, the control unit may set the opening degree of the flow rate adjusting valve in a manner so that the first flow rate becomes larger than the second flow rate as the difference increases.

### Supplementary Note 6

In the water electrolysis system according to Supplementary Note 2, the upper cell may be one of the water electrolysis cells that is located at the uppermost position in the stacking direction, and the lower cell may be one of the water electrolysis cells that is located at the lowermost position in the stacking direction.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these.

Furthermore, the same applies to a case where numerical values or mathematical expressions are used in the description of the above-described embodiments.

1. A water electrolysis system provided with a water electrolysis stack including a plurality of water electrolysis cells stacked in a direction lying along a vertical direction, a water introduction unit, a first water lead-out unit, and a second water lead-out unit,
wherein the first water lead-out unit is provided on an upper side of the water electrolysis stack, the second water lead-out unit is provided on a lower side of the water electrolysis stack, and the water introduction unit is provided between the first water lead-out unit and the second water lead-out unit in a stacking direction of the water electrolysis cells,
the water electrolysis system comprising a flow rate adjusting valve configured to relatively change a first flow rate that is a flow rate of water flowing through a first flow path portion extending from the first water lead-out unit, and a second flow rate that is a flow rate of the water flowing through a second flow path portion extending from the second water lead-out unit.

2. The water electrolysis system according to claim 1, further comprising:
a detection unit configured to detect information indicating a resistance of each of the plurality of water electrolysis cells; and
a control device comprising one or more processors that execute computer-executable instructions stored in a memory,
wherein the one or more processors execute the computer-executable instructions to cause the control device to:
acquire, in a state where a predetermined current flows through an upper cell which is one of the water electrolysis cells that is located on an upper side in the stacking direction, the information of the upper cell detected by the detection unit;
acquire, in a state where a predetermined current flows through a lower cell which is one of the water electrolysis cells that is located on a lower side in the stacking direction, the information of the lower cell detected by the detection unit;
calculate a difference in voltage value or resistance value between the upper cell and the lower cell based on the acquired information of the upper cell and the acquired information of the lower cell; and
set an opening degree of the flow rate adjusting valve based on the difference.

3. The water electrolysis system according to claim 2, wherein
in a case where the difference is equal to or greater than a threshold, the one or more processors cause the control device to set the opening degree of the flow rate adjusting valve in a manner so that the first flow rate is larger than the second flow rate.

4. The water electrolysis system according to claim 3, wherein
when the difference that has become equal to or greater than the threshold becomes less than the threshold, the one or more processors cause the control device to set the opening degree of the flow rate adjusting valve in a manner so that the first flow rate approaches the second flow rate.

5. The water electrolysis system according to claim 2, wherein
the one or more processors cause the control device to set the opening degree of the flow rate adjusting valve in a manner so that the first flow rate becomes larger than the second flow rate as the difference increases.

6. The water electrolysis system according to claim 2, wherein
the upper cell is one of the water electrolysis cells that is located at an uppermost position in the stacking direction, and
the lower cell is one of the water electrolysis cells that is located at a lowermost position in the stacking direction.
